(19) United States
(12) Patent Application Publication
(10) Pub. No.: US 2003/0095252 A1
(43) Pub. Date: May 22, 2003

(54) Method and apparatus for defect analysis of wafers

(75) Inventor: Robert Mainberger, Braunfels (DE)

Correspondence Address: DAVIDSON, DAVIDSON & KAPPEL, LLC, 485 SEVENTH AVENUE, 14TH FLOOR, NEW YORK, NY, 10018, US

(73) Assignee: Leica Microsystems Semiconductor GmbH, Wetzlar (DE)

(21) Appl. No.: 10/300,396

(22) Filed: Nov. 20, 2002

(30) Foreign Application Priority Data
Nov. 22, 2001 (DE) DE 101 57 244.1-5

(51) Int. Cl. G01N 21/00

(52) U.S. Cl. 356/237.2

(57) ABSTRACT

A method for defect analysis of wafers and a defect analysis system are disclosed. The defect analysis system has an image processing unit and an optical scanning apparatus, which is a flatbed scanner.

### CROSS REFERENCE TO RELATED APPLICATIONS

This application claims priority of the German patent application 101 57 244.1 which is incorporated by reference herein.

### FIELD OF THE INVENTION

The invention concerns a method for defect analysis of wafers.

The invention furthermore concerns a defect analysis system for wafers, having an optical scanning apparatus and an image processing unit.

### BACKGROUND OF THE INVENTION

Apparatuses for wafer inspection are widely known.

German Unexamined Application DE 34 22 143 A1 discloses a device for wafer inspection having a laser scanning microscope whose objective focuses the scanning light beam with a shallow depth of field onto the examination area, the detected radiation used for measuring the intensity of the light reflected from the examination area being constituted by a portion of the scanning beam of the laser scanning microscope. In a confocal arrangement, the examination plane is determined by the focal plane of the microscope objective. The scanning microscope contains an active scanning mirror with electronically controllable refractive power, activation of which allows the focal plane or examination plane to be modified (i.e. raised and/or lowered) with respect to a wafer-defined reference plane. Scanning of the wafer is accomplished in point-by-point fashion, by the fact that the scanning light beam is guided line-by-line over the wafer.

Depending on the focal length of the microscope objective, the size of the image field varies between 100 μm and several mm, and the image point size varies correspondingly between 0.05 μm and a few μm.

U.S. Pat. No. 5,917,588 discloses a method for inspecting the surfaces of a specimen, in particular for inspecting wafers, and an inspection system. The inspection system contains a complex dark-field illumination system and/or a complex wide-field illumination system having several stationary individual light sources. The system is capable of detecting defects that are larger than 25 μm.

Flat-bed scanners are known to PC users for scanning paper originals.

A disadvantage of the system known from German Unexamined Application DE 34 22 143 A1 is its slowness and the physically very limited image field. Scanning a wafer having a usual diameter of 300 mm would take hours, and the resolution thereby obtained would be better than necessary for coarse defect analysis.

The aforementioned inspection system known from U.S. Pat. No. 5,917,588 is complex and costly. The inspection system moreover requires times on the order of minutes to examine a wafer only 200 mm in diameter.

### SUMMARY OF THE INVENTION

It is therefore the object of the invention to describe a simple, fast, and economical method for defect analysis of wafers.

The aforesaid object is achieved by means of a method for defect analysis of wafers that is characterized by the following steps:

generating image data by optical scanning of the wafer with a flatbed scanner;

transmitting the image data to an image processing unit; and

evaluating, in the image processing unit, the image data that were generated.

A further object of the invention is to describe a simple, fast, efficient and also economical defect analysis system for wafers.

This object is achieved by means of a defect analysis system which is characterized in that the optical scanning apparatus is a flatbed scanner.

The invention has the advantage that even large wafers 300 mm in diameter can be examined for defects, with sufficiently high resolution, in fractions of a minute.

The flatbed scanner is preferably made for office applications. This kind of flatbed scanners is cheap, reliable is and usually available in most computer shops.

In a preferred embodiment, optical scanning of the wafer comprises illumination of the wafer with illuminating light and detection of detected light proceeding from the wafer. White or colored light-emitting diodes are preferably used for illumination. Cold-light sources can also be used for illumination.

In another preferred embodiment, the wavelength of the illuminating light is selectable. The method according to the present invention preferably contains the further step of selecting the wavelength of the illuminating light. In a variant embodiment, optical scanning is performed several times sequentially with illuminating light of a different wavelength each time.

The image processing unit preferably comprises a PC having software for image analysis and image evaluation. The flatbed scanner can be embodied as a line scanner. The flatbed scanner of the defect analysis system comprises at least one illumination unit that emits illuminating light.

A handling system that transports the wafers that are to be examined to the flatbed scanner is preferably provided. Scanning can preferably be accomplished from above in the case of an upside-down flatbed scanner, or from below, the upper side of the wafer being turned downward. The flatbed scanner can also be arranged vertically in the defect analysis system.

### BRIEF DESCRIPTION OF THE DRAWINGS

The subject matter of the invention is depicted schematically in the drawings and will be described below with reference to the Figures, identically functioning elements being labeled with the same reference characters. In the drawings:

FIG. 1 shows a defect analysis system; and

FIG. 2 shows a further defect analysis system.

### DETAILED DESCRIPTION OF THE INVENTION

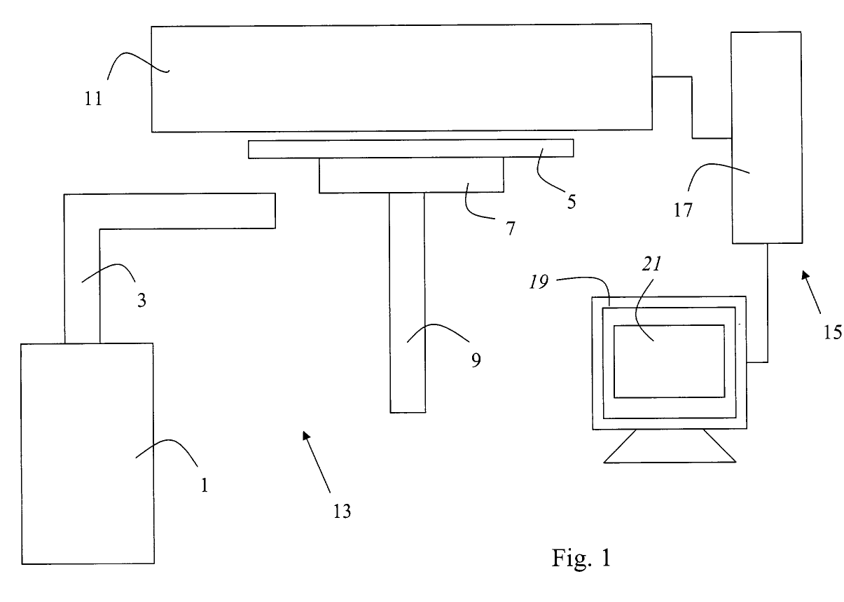

FIG. 1 shows a defect analysis system that includes a robot 1 having a controllable robot arm 3. The robot serves to remove wafer 5 from the cassettes (not shown) and transport it to wafer chuck 7. The wafer chuck has a vacuum suction system. Wafer chuck 7 is arranged on a motorized adjustable-height stage 9. Stage 9 transports wafer 5 in a linear motion to upside-down flatbed scanner 11, the latter not being touched in order not to damage the wafer. Robot 1, robot arm 3, the stage, and the chuck constitute a handling system 13. Flatbed scanner 11 is embodied as a line scanner, and scans wafer 5. The image data that are generated are forwarded to an image processing unit 15 that comprises a PC 17 having software for image analysis and image evaluation. PC 17 additionally controls handling system 13. Image 21 of wafer 5 is displayed on display 19, defect locations on wafer 5 being marked. Robot 1, rather than stage 9, could hold wafer 5 during scanning. A handling system comprising a stage 9 has the advantage, however, that robot 1 can transport further wafers to further flatbed scanners during scanning.

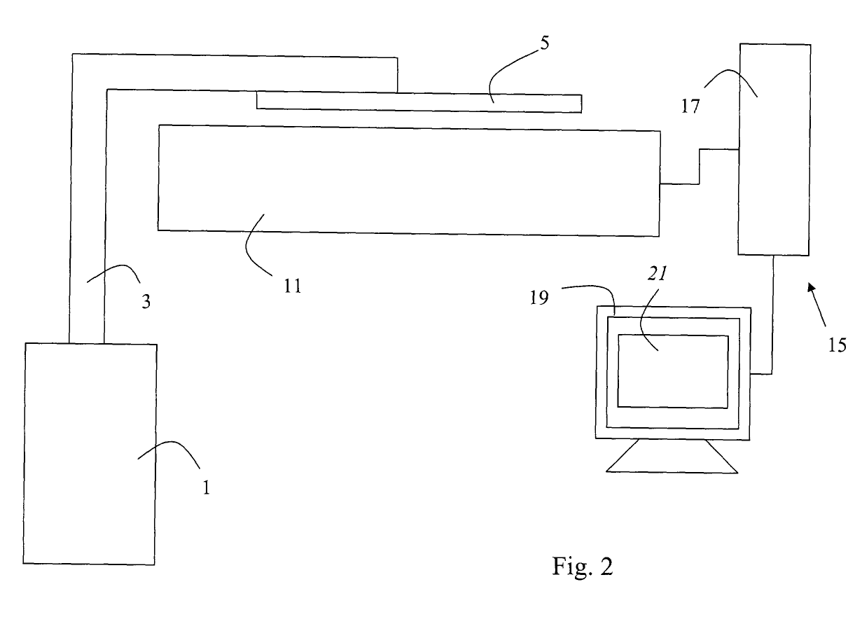

FIG. 2 shows a further defect analysis system in which flatbed scanner 11 is operated in the normal position. In this exemplary embodiment, robot arm 3 is configured so that the wafer is rotatable 180 degrees about the horizontal axis. Image data transmission and image data evaluation are performed as in the defect analysis shown in FIG. 1.

The invention has been described with reference to a particular embodiment. It is self-evident, however, that changes and modifications can be made without thereby leaving the range of protection of the claims below.

### PARTS LIST

1 Robot

3 Robot arm

5 Wafer

7 Wafer chuck

9 Stage

11 Flatbed scanner

13 Handling system

15 Image processing unit

17 PC

19 Display

21 Image

What is claimed is:

1. A method for defect analysis of wafers comprising the steps of:
generating image data by optical scanning of the wafer with a flatbed scanner;
transmitting the image data to an image processing unit; and
evaluating, in the image processing unit, the image data that were generated.

2. The method as defined in claim 1, wherein optical scanning of the wafer comprises illumination of the wafer with illuminating light and detection of detected light proceeding from the wafer.

3. The method as defined in claim 1, comprising the further step of
selecting the wavelength of the illuminating light.

4. The method as defined in claim 1, wherein optical scanning is performed several times sequentially with illuminating light of a different wavelength each time.

5. The method as defined in claim 1, wherein the image processing unit comprises a PC.

6. The method as defined in claim 1, wherein the flatbed scanner is a line scanner.

7. A defect analysis system for wafers, having an optical scanning apparatus and an image processing unit,
wherein the optical scanning apparatus is a flatbed scanner.

8. The defect analysis system as defined in claim 7, wherein the flatbed scanner comprises at least one illumination unit that emits illuminating light.

9. The defect analysis system as defined in claim 8, wherein the wavelength of the illuminating light is selectable.

10. The defect analysis system as defined in claim 7, wherein the image processing unit comprises a PC.

11. The defect analysis system as defined in claim 7, wherein the flatbed scanner is a line scanner.
